(19) United States
(12) Patent Application Publication
(10) Pub. No.: US 2025/0357794 A1
(43) Pub. Date: Nov. 20, 2025

(54) ANTENNAS FOR NEAR-FIELD COMMUNICATION WIRELESS CHARGING

(71) Applicants: STMicroelectronics (China) Investment Co. Ltd, Shanghai (CN); STMicroelectronics (Shenzhen) R&D Co. Ltd, Shenzhen (CN)

(72) Inventors: Dongyang TIAN, Suzhou (CN); Chao SUN, Shenzhen (CN); Yang LIU, Shenzhen (CN)

(73) Assignees: STMicroelectronics (China) Investment Co. Ltd, Shanghai (CN); STMicroelectronics (Shenzhen) R&D Co. Ltd, Shenzhen (CN)

(21) Appl. No.: 18/871,432

(22) PCT Filed: Jun. 29, 2022
(86) PCT No.: PCT/CN2022/102529

§ 371 Date: Dec. 3, 2024

(51) Int. Cl. H02J 50/20; H01Q 1/22; H01Q 7/06; H02J 50/10; H02J 50/40; H02J 50/80; H04B 5/72; H04B 5/79; H04R 1/10

(52) U.S. Cl. CPC H02J 50/20; H01Q 1/22; H01Q 7/06; H02J 50/10; H02J 50/40; H02J 50/80; H04B 5/72; H04B 5/79; H04R 1/1033

(57) ABSTRACT

The present disclosure is directed to an NFC wireless charging system for electronic devices. The system includes a power transmitting device having a charging transmitter, and a power receiving device having a charging receiver. Each of the charging transmitter and the charging receiver implements a coil antenna design in which the coil antenna charging the power receiver is inserted into the coil antenna of the charging transmitter, or vice versa.

### BACKGROUND

### Technical Field

The present disclosure is directed to antennas for wireless charging applications.

### Description of the Related Art

Near-field communication (NFC) technology is standardized by the NFC Forum; and is used in a variety of applications, such as device pairing, authentication, and parameter setting. With the rising popularity and adoption of NFC technology, the application areas of NFC technology are expanding to even more applications. Recently, the NFC forum has enabled wireless charging (WLC) of electronic devices using NFC technology. NFC WLC technology has the advantage and convenience of not having to use physical plugs and conductive contacts for charging devices.

In general, NFC wireless charging utilizes a charging transmitter, sometimes called a poller, and a charging receiver, sometimes called a listener. The charging transmitter wirelessly transmits power to the charging receiver; and the charging receiver charges a power storage, such as a battery. The charging receiver can receive as high as 1000 milliwatts during charging from the charging transmitter, which is sufficient for charging small electronic devices (e.g., styluses, audio earbuds, hearing aids, electric toothbrushes, electronic glasses, wearable devices, etc.).

### BRIEF SUMMARY

The present disclosure is directed to a wireless charging system in which a power transmitting device utilizes near field communication (NFC) to wirelessly charge a power receiving device. The power transmitting device includes an NFC transmitter and a transmitting antenna. The power receiving device includes a receiving antenna, an NFC receiver, charging circuitry, and a power storage.

The NFC transmitter of the power transmitting device provides an electrical signal to the transmitting antenna of the power transmitting device, which in turn creates an electromagnetic field and induces an electrical signal on the receiving antenna of the power receiving device. The charging circuitry of the power receiving device harvests the induced electrical signal, and stores the harvested power in the power storage of the power receiving device.

The transmitting antenna and the receiving antenna each implement a coil antenna design in which the coil of the receiving antenna is inserted into the coil of the transmitting antenna, or vice versa. The coil antenna design results in improved power transfer efficiency between the transmitting antenna and the receiving antenna, compared to PCB antennas. In addition, the coil antenna design is not limited in directivity like PCB antennas, and is able to transmit and receive power with 360 degrees coverage.

### BRIEF DESCRIPTION OF THE SEVERAL VIEWS OF THE DRAWINGS

In the drawings, identical reference numbers identify similar features or elements. The size and relative positions of features in the drawings are not necessarily drawn to scale.

FIG. 1 is a system according to an embodiment disclosed herein.

FIG. 2A is a side view of a transmitting antenna according to an embodiment disclosed herein.

FIG. 2B is an angled view of a transmitting antenna according to an embodiment disclosed herein.

FIG. 3A is a side view of a receiving antenna according to an embodiment disclosed herein.

FIG. 3B is an angled view of a receiving antenna according to an embodiment disclosed herein.

FIG. 4A is a side view of a receiving antenna inserted into a transmitting antenna according to an embodiment disclosed herein.

FIG. 4B is an angled view of a receiving antenna inserted into a transmitting antenna according to an embodiment disclosed herein.

FIG. 5 is a stylus and a mobile device according to an embodiment disclosed herein.

FIG. 6 is a stylus inserted into a mobile device according to an embodiment disclosed herein.

FIG. 7 is a pair of audio earbuds and a case according to an embodiment disclosed herein.

FIG. 8 is a pair of audio earbuds inserted into a case according to an embodiment disclosed herein.

FIG. 9 is an electronic ring and a charging stand according to an embodiment disclosed herein.

FIG. 10 is a cross-sectional view of an electronic ring and a charging stand according to an embodiment disclosed herein.

### DETAILED DESCRIPTION

In the following description, certain specific details are set forth in order to provide a thorough understanding of various aspects of the disclosed subject matter. However, the disclosed subject matter may be practiced without these specific details. In some instances, well-known structures and methods of manufacturing and using antennas, wireless charging circuitry, and electronic components have not been described in detail to avoid obscuring the descriptions of other aspects of the present disclosure.

Unless the context requires otherwise, throughout the specification and claims that follow, the word “comprise” and variations thereof, such as “comprises” and “comprising.” are to be construed in an open, inclusive sense, that is, as “including, but not limited to.”

Reference throughout the specification to “one embodiment” or “an embodiment” means that a particular feature, structure, or characteristic described in connection with the embodiment is included in at least one embodiment. Thus, the appearance of the phrases “in one embodiment” or “in an embodiment” in various places throughout the specification are not necessarily all referring to the same aspect. Furthermore, the particular features, structures, or characteristics may be combined in any suitable manner in one or more aspects of the present disclosure.

As discussed above, wireless charging (WLC) of electronic devices may now be performed with near-field communication (NFC) technology. NFC wireless charging utilizes a charging transmitter, sometimes called a poller, and a charging receiver, sometimes called a listener. The charging transmitter wirelessly transmits power to the charging receiver; and the charging receiver charges a power storage, such as a battery.

Transmission between the charging transmitter and the charging receiver is typically performed with flexible, bendable printed circuit board (PCB) antennas or three-dimensional (3D) antennas. PCB antennas are low-cost and small in size, but have relatively narrow directivity. Consequently, for PCB antennas, the relative positions of the charging transmitter and the charging receiver have to be fixed for effective transmission. In contrast, 3D antennas have larger directivity compared to PCB antennas, but have higher costs and are larger in size compared to PCB antennas. In addition, both PCB antennas have poor power transfer efficiency from the charging transmitter to the charging receiver (e.g., 20 to 30 percent efficiency).

The present disclosure is directed to an NFC wireless charging system for electronic devices. The system includes a charging transmitter in a power transmitting device, and a charging receiver in a power receiving device. The power transmitting device wirelessly charges the power receiving device. Each of the charging transmitter and the charging receiver implement a coil antenna design in which the coil antenna of the charging receiver is inserted into the coil antenna of the charging transmitter, or vice versa. The NFC wireless charging system disclosed herein results in improved power transfer efficiency compared to current systems that utilize PCB and three-dimensional antennas. In addition, the coil antennas are not limited in directivity like PCB antennas, and are able to transmit and receive power with 360 degrees coverage. Thus, the charging transmitter and the charging receiver disclosed herein do not have to be in the same relative positions each time wireless charging is performed.

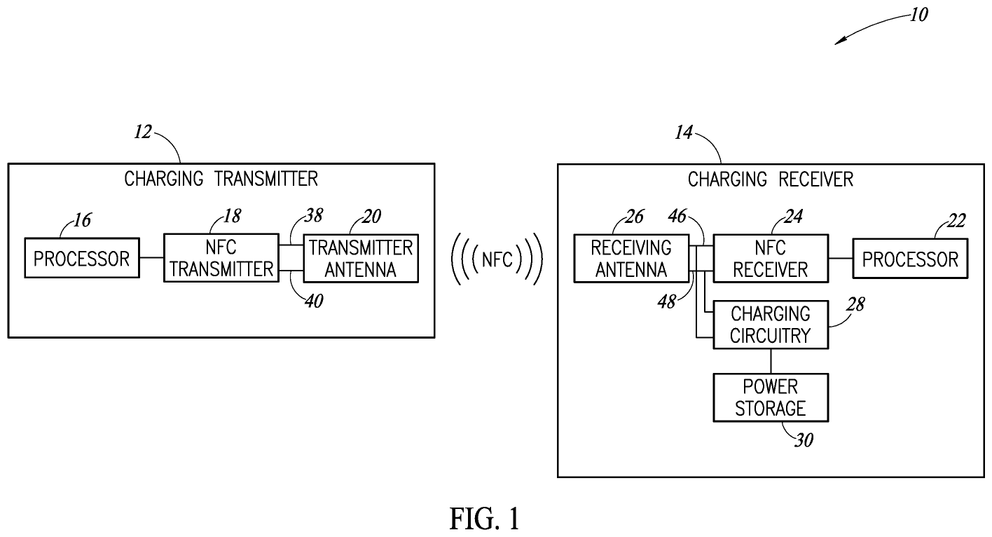

FIG. 1 is a system 10 according to an embodiment disclosed herein. The system 10 includes a charging transmitter 12 and a charging receiver 14. The charging transmitter 12 and the charging receiver 14 perform NFC communication with each other.

The charging transmitter 12 is included in a power transmitting device, and the charging receiver 14 is included in a power receiving device that is wirelessly charged by the power transmitting device. The power transmitting device and the power receiving device are physically separate devices that work in conjunction with each other. For example, the power receiving device may be a stylus, audio earbuds, hearing aids, an electric toothbrush, electronic glasses, or another type of electronic device; and the power transmitting device may be a portable device (e.g., a mobile phone, tablet, computer, etc.) that charges and accepts input from the stylus, or a charging case or dock that charges the audio earbuds, hearing aids, electric toothbrush, and electronic glasses.

In one embodiment, the power receiving device is configured to be inserted into the power transmitting device such that the receiving antenna 26 is also inserted into the transmitting antenna 20. In another embodiment, the power transmitting device is configured to be inserted into the power receiving device such that the transmitting antenna 20 is also inserted into the receiving antenna 26. Detailed examples of the power transmitting device and the power receiving device will be discussed in further detail below.

The charging transmitter 12, often referred to as a poller, communicates with and wirelessly provides power to the charging receiver 14. The charging transmitter 12 includes a processor 16, an NFC transmitter 18, and a transmitting antenna 20.

The processor 16 is electrically coupled to the NFC transmitter 18. The processor 16 controls and processes data for the charging transmitter 12. More specifically, the processor 16 controls and processes data generated by the NFC transmitter 18. For example, the processor 16 instructs the NFC transmitter 18 to initiate wireless charging of the power storage 30 of the charging receiver 14, in response to the NFC transmitter 18 detecting the presence of the charging receiver 14. In addition, the processor 16 instructs the NFC transmitter 18 to read/write data from/to the charging receiver 14 for a variety of applications, such as device pairing, authentication, and parameter setting.

The processor 16 may also communicate with the device that contains the charging transmitter 12. For example, the processor 16 informs the containing device of detection of the charging receiver 14, and receives instructions from the device to perform, for example, device pairing, authentication, and parameter setting. The processor may also perform WLC protocol procedures, such as power charging control and foreign object detection (FOD). The processor 16 may be any type of processor, controller, or signal processor configured to process data.

The NFC transmitter is electrically coupled between the processor 16 and the transmitting antenna 20. The NFC transmitter 18, often referred to as an NFC reader, detects and performs NFC communication with the NFC receiver 24 of the charging receiver 14 via the transmitting antenna 20 and the receiving antenna 26. For example, the NFC transmitter 18 reads data from and writes data to the NFC receiver 24 using NFC communication for a variety of applications, such as device pairing, authentication, and parameter setting.

The NFC transmitter 18 also wirelessly charges the power storage 30 of the charging receiver 14 via the transmitting antenna 20 and the receiving antenna 26 using NFC technology. For example, the NFC transmitter 18 provides an electrical signal (e.g., electrical current) to the transmitting antenna 20 (e.g., generates and transmits the electrical signal to the transmitting antenna, or configures the transmitting antenna 20 to receive the electrical signal), which in turn creates an electromagnetic field and induces an electrical signal (e.g., electrical current) on the receiving antenna 26. As will be discussed in further detail below, the receiving antenna 26 is inserted into the transmitting antenna 20 during charging, or the transmitting antenna 20 is inserted into the receiving antenna 26 during charging.

The transmitting antenna 20 is electrically coupled to the NFC transmitter 18. The transmitting antenna 20 is a conductive structure that communicates with the receiving antenna 26. For example, the transmitting antenna 20 transmits signals to and receives signals from the receiving antenna 26. As discussed above, during wireless charging, the transmitting antenna 20 generates an electromagnetic field in response to receiving an electrical signal (e.g., electrical current) from the NFC transmitter 18.

The transmitting antenna 20 is a coil antenna having a plurality of turns. A first end 38 and a second end 40 of the coil of the transmitting antenna 20 is electrically coupled to the NFC transmitting antenna 20. The transmitting antenna 20 will be discussed in further detail below.

The charging receiver 14, often referred to as a listener, communicates with and wirelessly receives power from the charging transmitter 12. The charging transmitter 12 includes a processor 22, an NFC receiver 24, a receiving antenna 26, charging circuitry 28, and a power storage 30.

The processor 22 is electrically coupled to the NFC receiver 24. The processor 22 controls and processes data for the charging receiver 14. More specifically, the processor 16 controls and processes data generated by the NFC receiver 24. For example, the processor 22 instructs the NFC receiver 24 to initiate wireless charging of the power storage 30, in response to the NFC receiver 24 being detected by the NFC transmitter 18. In addition, the processor 22 instructs the NFC receiver 24 to read/write data from/to the charging transmitter 12 for a variety of applications, such as device pairing, authentication, and parameter setting.

The processor 22 may also communicate with the device that contains the charging receiver 14. For example, the processor 22 informs the containing device that the NFC receiver 24 has been detected by the NFC transmitter 18, and receives instructions from the device to perform, for example, device pairing, authentication, and parameter setting. The processor 22 may be any type of processor, controller, or signal processor configured to process data.

The NFC receiver 24 is electrically coupled between the processor 22 and the receiving antenna 26. The NFC receiver 24, often referred to as an NFC tag. performs NFC communication with the NFC transmitter 18 of the charging receiver 14 via the receiving antenna 26 and the transmitter antenna 20. For example, the NFC receiver 24 reads/writes data from/to the NFC transmitter 18 using NFC communication for a variety of applications, such as device pairing, authentication, and parameter setting.

The receiving antenna 26 is electrically coupled to the NFC receiver 24 and the charging circuitry 28. The receiving antenna 26 is a conductive structure that communicates with the transmitting antenna 20. For example, the receiving antenna 26 transmits signals to and receives signals from the transmitting antenna 20.

As discussed above, during wireless charging, the transmitting antenna 20 generates an electromagnetic field in response to being provided an electrical signal (e.g., electrical current) by the NFC transmitter 18. The electromagnetic field induces an electrical signal (e.g., electrical current) on the receiving antenna 26. The inductance on the receiving antenna 26 may be, for example, between 100 nanohenry and 4,000 nanohenry. As will be discussed in further detail below, the receiving antenna 26 is inserted into the transmitting antenna 20 during charging, or the transmitting antenna 20 is inserted into the receiving antenna 26 during charging.

The receiving antenna 26 is a coil antenna having a plurality of turns. A first end 46 and a second end 48 of the coil of the receiving antenna 26 is electrically coupled to the NFC receiver 24 and the charging circuitry 28. The receiving antenna 26 will be discussed in further detail below.

The charging circuitry 28 is electrically coupled to the receiving antenna 26. During wireless charging, the charging circuitry 28 harvests or collects the electrical signal (e.g., electrical current) induced on the receiving antenna 26 by the electromagnetic field generated by the transmitting antenna 20. In addition, the charging circuitry 28 converts the electrical signal to a usable level to charge the power storage 30.

The charging circuitry 28 includes various electrical components (e.g., resistors, capacitors, amplifiers, transistors, etc.) to harvest and convert the electrical signal on the receiving antenna 26. In one embodiment, the charging circuitry 28 includes a rectifier circuit to convert an alternating current (AC) signal generated on the receiving antenna 26 to a direct current (DC) signal, and a DC to DC converter to adjust the DC signal to a usable level for charging the power storage 30.

The power storage 30 stores power harvested by the charging circuitry 28. The power storage 30 provides power to the charging receiver 14 and to the device containing the charging receiver 14. The power storage 30 may be any type of power storage, such as a battery. Although the power storage 30 is shown to be included in the charging receiver 14, the power storage 30 may also be a power storage of the device containing the charging receiver 14.

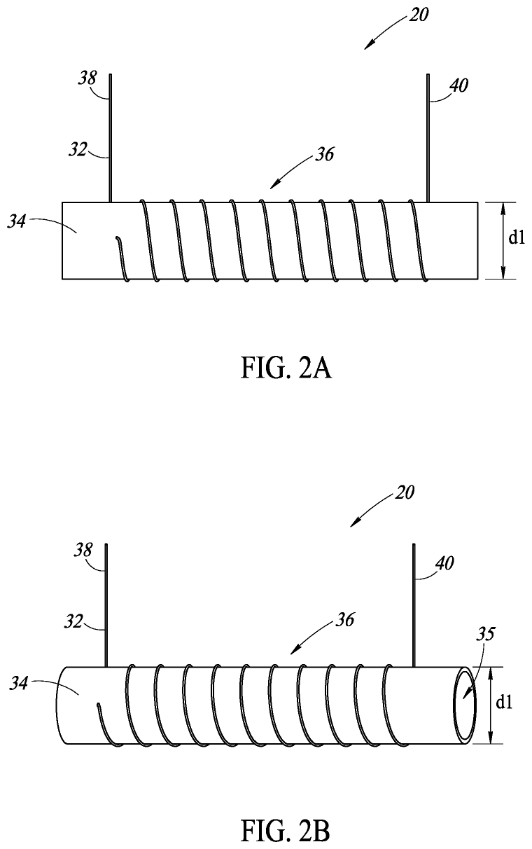

FIG. 2A is a side view of the transmitting antenna 20 according to an embodiment disclosed herein. FIG. 2B is an angled view the transmitting antenna 20 according to an embodiment disclosed herein. It is beneficial to review FIGS. 2A and 2B together. The transmitting antenna 20 is a coil antenna including a conductor 32 and a body 34.

The conductor 32 is a wire made of a conductive material, such as copper. The conductor 32 is shaped into a coil having a plurality of turns 36. The coils of the conductor 32 allow the directivity of the transmitting antenna 20 to be 360 degrees. As such, the transmitting antenna 20 is able to transmit power with 360 degrees coverage, and the charging transmitter 12 and the charging receiver 14 do not have be in the same relative positions each time wireless charging is performed. The diameter, material, number of turns, and length of the conductor 32 can be changed depending on the application.

As discussed above, a first end 38 and a second end 40 of the conductor 32 is electrically coupled to the transmitting antenna 20. An electrical signal (e.g., electrical current) is propagated through the conductor 32, which in turn creates an electromagnetic field.

The plurality of turns 36 are wrapped around the body 34, which is made of a non-conducting, insulating material. The body 34 is tubular or cylindrical in shape with a through hole 35 extending throughout the entire length of the body 34. It is noted that the body 34 is optional, and may be removed from the transmitting antenna 20.

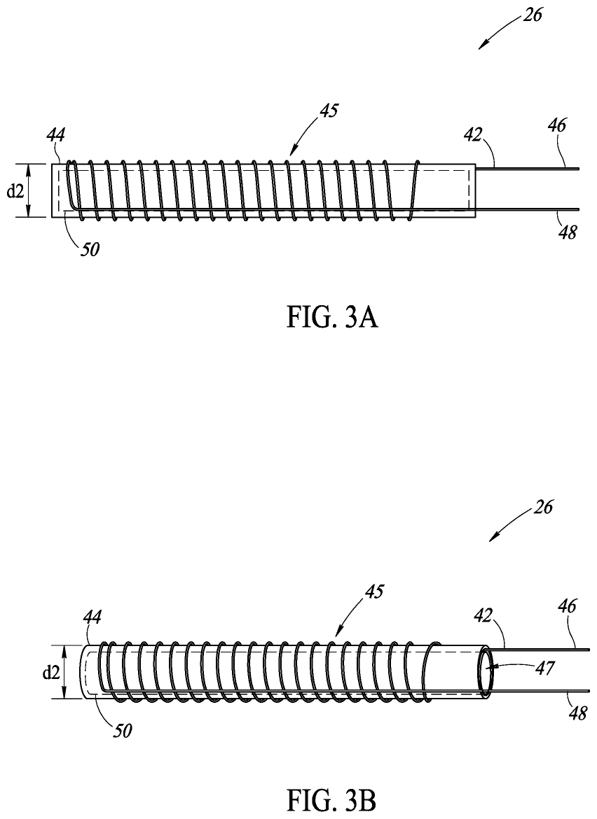

FIG. 3A is a side view of the receiving antenna 26 according to an embodiment disclosed herein. FIG. 3B is an angled view of the receiving antenna 26 according to an embodiment disclosed herein. It is beneficial to review FIGS. 3A and 3B together. Similar to the transmitting antenna 20, the receiving antenna 26 is a coil antenna including a conductor 42 and body 44.

The conductor 42 is a wire made of a conductive material, such as copper. The conductor 42 is shaped into a coil having a plurality of turns 45. The coils of the conductor 42 allow the directivity of the receiving antenna 26 to be 360 degrees. As such, the receiving antenna 26 is able to receive power with 360 degrees coverage, and the charging transmitter 12 and the charging receiver 14 do not have be in the same relative positions each time wireless charging is performed. The diameter, material, number of turns, and length of the conductor 42 can be changed depending on the application.

As discussed above, a first end 46 and a second end 48 of the conductor 42 is electrically coupled to the NFC receiver 24 to process the signal received on the receiving antenna 26, and the charging circuitry 28 to harvest energy induced on the receiving antenna 26.

The plurality of turns 45 are wrapped around the body 44, which is made of a non-conducting, insulating material. The plurality of turns 45 may also be wrapped around a magnetic core 50, without the body 44, discussed below. The body 44 is tubular or cylindrical in shape with a through hole 47 extending throughout the entire length of the body 44. It is noted that the body 44 is optional, and may be removed from the receiving antenna 26.

In one embodiment, as shown in FIGS. 3A and 3B, a magnetic core 50 is inserted into the through hole 47 of the body 44. As such, the magnetic core 50 has a smaller diameter than the body 44. The magnetic core strengthens the electrical signal received on the receiving antenna 26, and, as a result, improves the overall power transfer efficiency between the receiving antenna 26 and the transmitting antenna 20 during wireless charging. In one embodiment, the magnetic core 50 is cylindrical in shape. In one embodiment, the magnetic core 50 and the body 44 have the same length. Stated differently, the magnetic core 50 extends the entire length of the body 44. It is noted that the magnetic core 50 is optional, and may be removed from the receiving antenna 26.

In one embodiment, the body 44 is removed from the receiving antenna 26, and the plurality of turns 45 are instead wrapped around the magnetic core 50.

As discussed above, during wireless charging, the transmitting antenna 20 generates an electromagnetic field in response to receiving an electrical signal from the NFC transmitter 18. The electromagnetic field induces an electrical signal on the receiving antenna 26, which is then harvested by the charging circuitry 28. In order to improve power transfer efficiency between the transmitting antenna 20 and the receiving antenna 26, the receiving antenna 26 is inserted into the transmitting antenna 20. Conversely, the transmitting antenna 20 is inserted into the receiving antenna 26. As a result, the power transfer efficiency between the transmitting antenna 20 and the receiving antenna 26 is greater than 30 percent.

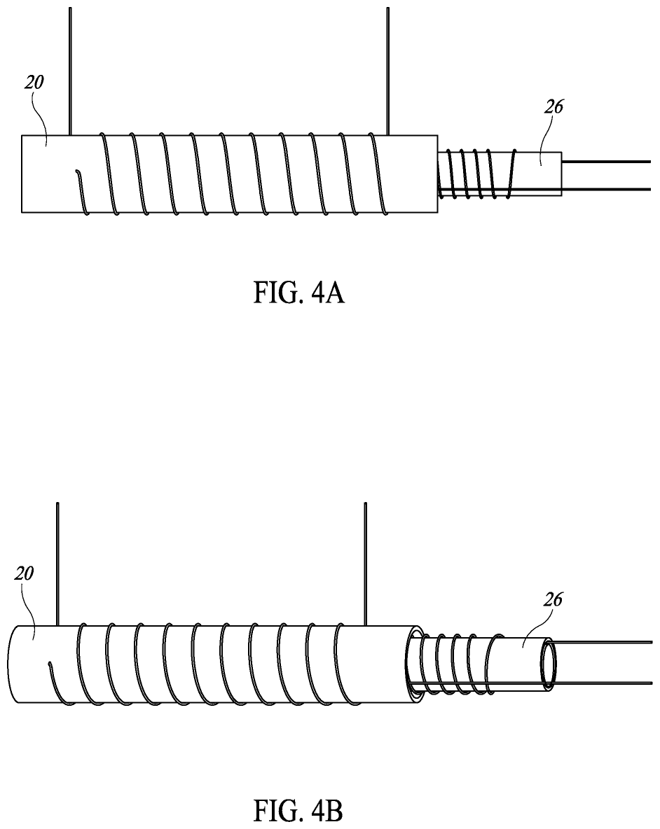

FIG. 4A is a side view of the receiving antenna 26 inserted into the transmitting antenna 20 according to an embodiment disclosed herein. FIG. 4B is an angled view of the receiving antenna 26 inserted into the transmitting antenna 20 according to an embodiment disclosed herein. It is beneficial to review FIGS. 4A and 4B together.

The receiving antenna 26 is inserted into the through hole 35 of the body 34 of the transmitting antenna 20. In order for the receiving antenna 26 to be able to fit in the transmitting antenna 20, referring to FIGS. 2B and 3B, the diameter d2 of the receiving antenna 26 is smaller than the diameter d1 of the transmitting antenna 20. Stated differently, the diameter of the body 44 of the receiving antenna 26 is smaller than the diameter of the body 34 of the transmitting antenna 20, and the diameters of the turns 45 of the receiving antenna 26 is smaller than the diameters of the turns 36 of the transmitting antenna 20.

In FIGS. 4A and 4B, the receiving antenna 26 is partially inserted into the transmitting antenna 20. The receiving antenna 26 may be fully inserted into the transmitting antenna 20 during wireless charging such that the entire body 44 of the receiving antenna 26 is within the body 34 of the transmitting antenna 20, with the first end 46 and the second end 48 extending out of the body 34 of the transmitting antenna 20.

As mentioned above, the transmitting antenna 20 may, instead, be inserted into the receiving antenna 26. In this embodiment, the antennas shown in FIGS. 2A to 4B may still be used. However, the antennas used for the transmitting antenna 20 and the receiving antenna 26 are swapped. Namely, the antenna shown in FIGS. 2A and 2B is the receiving antenna 26, the antenna shown in FIGS. 3A and 3B is the transmitting antenna 20, and the transmitting antenna 20 is inserted into the receiving antenna 26 as shown in FIGS. 4A and 4B. As such, referring to FIGS. 2B and 3B in this embodiment, the diameter d2 of the transmitting antenna 20 is smaller than the diameter d1 of the receiving antenna 26 in order for the transmitting antenna 20 to be able to fit in the receiving antenna 26. Stated differently, the diameter of the body 44 of the transmitting antenna 20 is smaller than the diameter of the body 34 of the receiving antenna 26, and the diameters of the turns 45 of the transmitting antenna 20 are smaller than the diameters of the turns 36 of the receiving antenna 26.

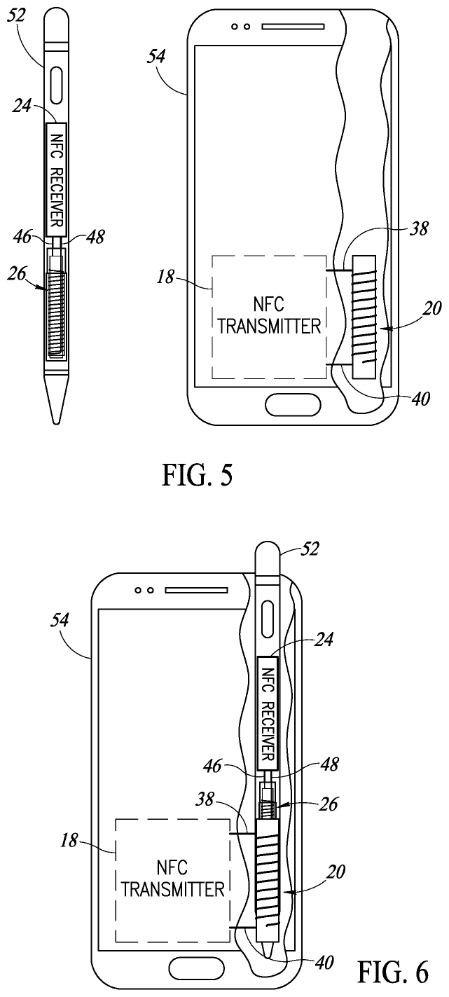

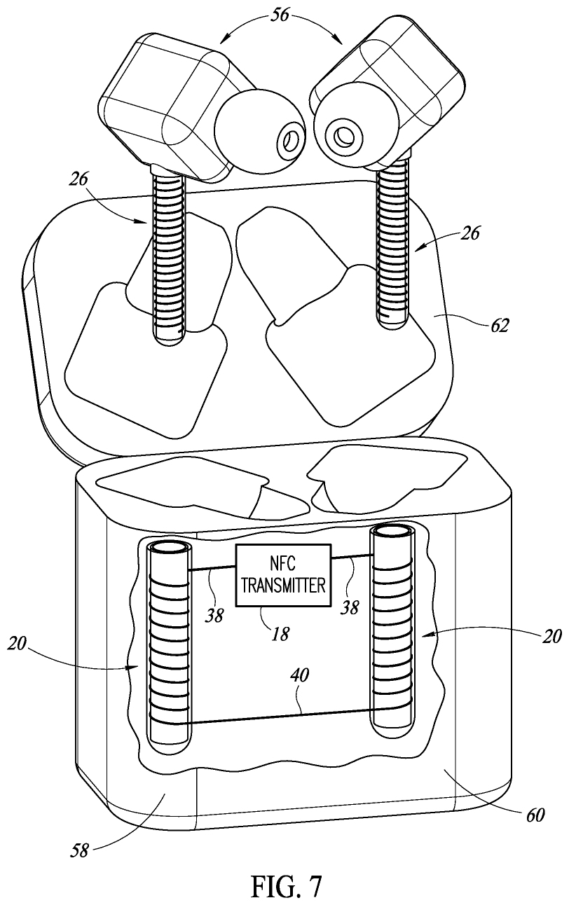

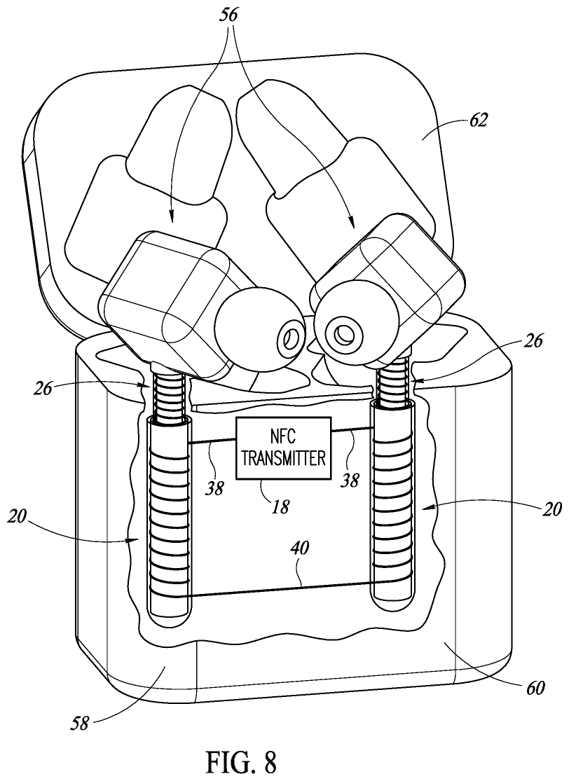

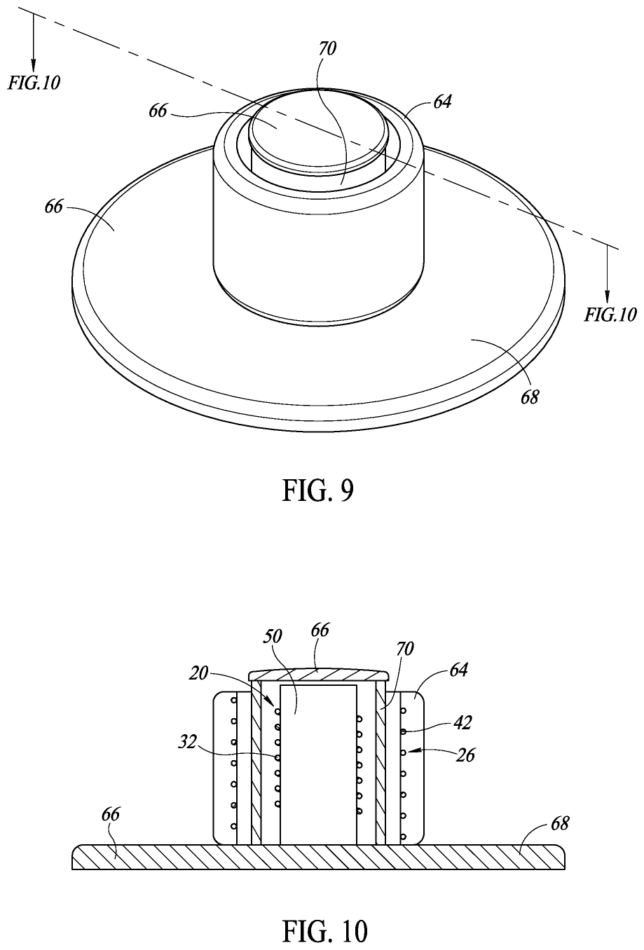

As discussed above, the charging transmitter 12 is included in a power transmitting device, and the charging receiver 14 is included in a power receiving device that is wirelessly charged by the power transmitting device. FIGS. 5 and 6 show a case where the power receiving device is a stylus, and the power transmitting device is a mobile device, such as a phone or tablet. FIGS. 7 and 8 show a case where the power receiving device is a pair of audio earbuds, and the power transmitting device is a case for the earbuds. FIGS. 9 and 10 show a case where the power receiving device is an electronic ring, and the power transmitting device is a charging stand for the electronic ring. Other types of devices are also possible.

FIG. 5 is a stylus 52 and a mobile device 54 according to an embodiment disclosed herein. FIG. 6 is the stylus 52 inserted into the mobile device 54 according to an embodiment disclosed herein. It is beneficial to review FIGS. 5 and 6 together.

The stylus 52 is an electronic pen configured to input commands to the mobile device 54. For example, the stylus 52 may be used to write, draw, and select text and objects displayed on the screen of the mobile device 54. As shown in FIG. 5, the stylus 52 is shaped similar to a pen.

The stylus 52 is a power receiving device, and is wirelessly charged by the mobile device 54. The stylus 52 includes the charging receiver 14 as discussed above with respect to FIG. 1. As such, the stylus 52 includes the processor 22, the NFC receiver 24, the receiving antenna 26, the charging circuitry 28, and the power storage 30. It is noted that the processor 22, the charging circuitry 28, and the power storage 30 are not shown in FIGS. 5 and 6 for simplicity purposes, but are coupled to the NFC receiver 24 and the receiving antenna 26 as discussed above with respect to FIG. 1.

The mobile device 54 is an electronic device having a screen, such as a touch screen, that accepts input from the stylus 52. The mobile device 54 may be, for example, a phone or a tablet.

The mobile device 54 is a power transmitting device, and wirelessly charges the stylus 52. The mobile device 54 includes the charging transmitter 12 as discussed above with respect to FIG. 1. As such, the mobile device 54 includes the processor 16, the NFC transmitter 18, and the transmitting antenna 20. It is noted that the processor 16 is not shown in FIGS. 5 and 6 for simplicity purposes, but are coupled to the NFC transmitter 18 and the transmitting antenna 20 as discussed above with respect to FIG. 1.

As best shown in FIG. 6, the stylus 52 is configured to be inserted into the mobile device 54 such that the receiving antenna 26 is also inserted into the transmitting antenna 20. The receiving antenna 26 is inserted into the transmitting antenna 20 as discussed above with respect to FIGS. 4A and 4B. During wireless charging and while the receiving antenna 26 is inserted into the transmitting antenna 20, the transmitting antenna 20 generates an electromagnetic field in response to receiving an electrical signal (e.g., electrical current) from the NFC transmitter 18. The electromagnetic field induces an electrical signal (e.g., electrical current) on the receiving antenna 26, and the charging circuitry 28 harvests or collects the electrical signal. The harvested power is then stored in the power storage 30 to be used by the stylus 52. As discussed above, it is also possible for the transmitting antenna 20 to, instead, be inserted into the receiving antenna 26.

FIG. 7 is a pair of audio earbuds 56 and a case 58 according to an embodiment disclosed herein. FIG. 8 is the pair of audio earbuds 56 inserted into the case 58 according to an embodiment disclosed herein. It is beneficial to review FIGS. 7 and 8 together.

The pair of audio earbuds 56 are audio headphones that are inserted into respective ears of a user. The earbuds 56 play audio, such as music and voice calls. The earbuds 56 are configured to be held and stored in the case 58.

Each of the earbuds 56 is a power receiving device, and is wirelessly charged by the case 58. Each of the earbuds 56 includes the charging receiver 14 as discussed above with respect to FIG. 1. As such, each of the earbuds 56 includes the processor 22, the NFC receiver 24, the receiving antenna 26, the charging circuitry 28, and the power storage 30. It is noted that the processor 22, the NFC receiver 24, the charging circuitry 28, and the power storage 30 are not shown in FIGS. 7 and 8 for simplicity purposes, but are coupled to the receiving antenna 26 as discussed above with respect to FIG. 1.

The case 58 is a housing configured to hold and store the earbuds 56. The case 58 includes a lower portion 60 in which the earbuds 56 are inserted into, and an upper portion 62 that moves between an open and closed position. In the open position, as best shown in FIG. 8, the earbuds 56 may be inserted into the case 58. In the closed position, the upper portion 62 is in contact with the lower portion 60, and the earbuds 56 are enclosed by the case 58.

The case 58 is a power transmitting device, and wirelessly charges the earbuds 56. The case 58 includes the charging transmitter 12 as discussed above with respect to FIG. 1. As such, the case 58 includes the processor 16, the NFC transmitter 18, and the transmitting antenna 20. However, in contrast to the embodiment shown in FIG. 1, the charging transmitter 12 includes two transmitting antennas 20 configured to receive the earbuds 56. Further, the second ends 40 of the transmitting antennas 20, more specifically of the conductors 32, are electrically coupled to each other. Stated differently, the second end 40 of the transmitting antenna 20 of one of the earbuds 56 is electrically coupled to the second end 40 of the transmitting antenna 20 of the other of the earbuds 56. This allows a single charging transmitter 12 to be used for both of the earbuds 56. It is noted that the processor 16 is not shown in FIGS. 7 and 8 for simplicity purposes, but is coupled to the NFC transmitter 18 and the transmitting antenna 20 as discussed above with respect to FIG. 1.

As best shown in FIG. 8, the earbuds 56 are configured to be inserted into the case 58 such that the receiving antennas 26 are also respectively inserted into the transmitting antennas 20. The receiving antennas 26 are respectively inserted into the transmitting antennas 20 as discussed above with respect to FIGS. 4A and 4B. During wireless charging and while the receiving antennas 26 are inserted into the transmitting antennas 20, each of the transmitting antennas 20 generate an electromagnetic field in response to receiving an electrical signal (e.g., electrical current) from the NFC transmitter 18. The electromagnetic field induces an electrical signal (e.g., electrical current) on each of the receiving antennas 26, and the respective charging circuitries 28 harvest or collect the electrical signal. The harvested power is then stored in the power storage 30 of each of the earbuds 56 to be used by the earbuds 56. As discussed above, it is also possible for the transmitting antennas 20 to, instead, be inserted into the receiving antennas 26, respectively.

FIG. 9 is an electronic ring 64 and a charging stand 66 according to an embodiment disclosed herein. FIG. 10 is a cross-sectional view, along the axis shown in FIG. 9, of the electronic ring 64 and the charging stand 66 according to an embodiment disclosed herein. It is beneficial to review FIGS. 9 and 10 together.

The electronic ring 64 is an electronic ring, often referred to as a smart ring, configured to be worn on a user's finger. The electronic ring 64 is configured to provide feedback to the user using, for example, lights or vibrations; and measure various characteristics of the user (e.g., sleep patterns, activity, etc.) as a health tracker.

The electronic ring 64 is a power receiving device, and is wirelessly charged by the charging stand 66. The electronic ring 64 includes the charging receiver 14 as discussed above with respect to FIG. 1. As such, the electronic ring 64 includes the processor 22, the NFC receiver 24, the receiving antenna 26, the charging circuitry 28, and the power storage 30. It is noted that the processor 22, the NFC receiver 24, the charging circuitry 28, and the power storage 30 are not shown in FIGS. 9 and 10 for simplicity purposes, but are coupled to the receiving antenna 26 as discussed above with respect to FIG. 1. In addition, in the embodiment shown in FIGS. 9 and 10, the receiving antenna 26 does not include the body 44 and the magnetic core 50.

The charging stand 66 is a stand configured to hold and wirelessly charge the electronic ring 64. The charging stand 66 includes a base portion 68 and a ring portion 70. The ring portion 70 extends from an upper surface of the base portion 68, and is tubular or cylindrical in shape. The ring portion 70 has a smaller diameter than the electronic ring 64. As such, the electronic ring 64 is able to be placed around the ring portion 70 and on the base portion 68.

The charging stand 66 is a power transmitting device, and wirelessly charges the electronic ring 64. The charging stand 66 includes the charging transmitter 12 as discussed above with respect to FIG. 1. As such, the charging stand 66 includes the processor 16, the NFC transmitter 18, and the transmitting antenna 20. It is noted that the processor 16 and the NFC transmitter 18 are not shown in FIGS. 9 and 10 for simplicity purposes, but are coupled to the transmitting antenna 20 as discussed above with respect to FIG. 1. In addition, in the embodiment shown in FIGS. 9 and 10, the transmitting antenna 20 does not include the body 34, but includes the magnetic core 50.

As best shown in FIG. 10, the electronic ring 64 is configured to be positioned on the base portion 68 and encircling the ring portion 70 such that the ring portion 70 and the transmitting antenna 20 are inserted into the receiving antenna 26. During wireless charging and while the transmitting antenna 20 is inserted into the receiving antenna 26, the transmitting antenna 20 generates an electromagnetic field in response to receiving an electrical signal (e.g., electrical current) from the NFC transmitter 18. The electromagnetic field induces an electrical signal (e.g., electrical current) on the receiving antenna 26, and the charging circuitry 28 harvests or collects the electrical signal. The harvested power is then stored in the power storage 30 to be used by the electronic ring 64. As discussed above, it is also possible for the receiving antenna 26 to, instead, be inserted into the transmitting antenna 20.

The various embodiments disclosed herein provide a power transmitting device having a charging transmitter, and a power receiving device having a charging receiver. The power transmitting device utilizes NFC to wirelessly charge the power receiving device. In order to improve power transfer efficiency between the power transmitting device and the power receiving device, each of the power transmitting device and the power receiving device implements a coil antenna design in which the coil antenna of the power receiving device is inserted into the coil antenna of the receiving device, or vice versa. The coil antennas are also able to transmit and receive power with 360 degrees coverage.

A system may be summarized as including a first device including a charging transmitter, the charging transmitter including: a near field communication (NFC) transmitter; and a first antenna electrically coupled to the NFC transmitter, the NFC transmitter configured to provide a first electrical signal to the first antenna; and a second device including a charging receiver, the charging receiver including: an NFC receiver; a second antenna electrically coupled to the NFC receiver, one antenna of the first and second antennas is configured to be inserted into the other antenna of the first and second antennas, the first antenna configured to induce a second electrical signal on the second antenna in response to receiving the first electrical signal; charging circuitry configured to harvest power from the second electrical signal; and a power storage configured to store the power.

Each of the first and second antennas may be a coil antenna.

Each of the first and second antennas may include a body made of an insulating material; and a conductor having a plurality of turns wrapped around the body.

The body may be cylindrical, and a diameter of the body of the first antenna may be different from a diameter of the body of the second antenna.

The conductor of the first antenna may include first and second ends electrically coupled to the NFC transmitter, and the conductor of the second antenna may include first and second ends electrically coupled to the NFC receiver.

The NFC transmitter may be configured to perform NFC communication with the NFC receiver using the first and second antennas.

The charging transmitter may include a magnetic core in the first antenna.

The charging receiver may include a magnetic core in the first antenna.

The first device may be a mobile device, and the second device may be a stylus configured to be inserted into the mobile device; or the first device is a charging stand, and the second device is a ring configured to be positioned on the charging stand.

The first antenna may be configured to be inserted into the second antenna.

The second antenna may be configured to be inserted into the first antenna.

A system may be summarized as including a charging transmitter including: a near field communication (NFC) transmitter; a first antenna electrically coupled to the NFC transmitter; and a second antenna electrically coupled to the NFC transmitter, the NFC transmitter configured to provide a first electrical signal to the first and second antennas; a first charging receiver including: a first NFC receiver; a third antenna electrically coupled to the first NFC receiver, the third antenna configured to be inserted into the first antenna, the first antenna configured to induce a second electrical signal on the third antenna in response to receiving the first electrical signal; first charging circuitry configured to harvest power from the second electrical signal; and a first power storage configured to store the power harvested by the first charging circuitry; and a second charging receiver including: a second NFC receiver; a fourth antenna electrically coupled to the second NFC receiver, the fourth antenna configured to be inserted into the second antenna, the second antenna configured to induce a third electrical signal on the fourth antenna in response to receiving the first electrical signal; second charging circuitry configured to harvest power from the third electrical signal; and a second power storage configured to store the power harvested by the second charging circuitry.

Each of the first, second, third, and fourth antennas may be a coil antenna.

Each of the first, second, third, and fourth antennas may include a body made of an insulating material; and a conductor having a plurality of turns wrapped around the body.

A first end of the conductor of the third antenna may be electrically coupled to the first NFC receiver, a first end of the conductor of the fourth antenna may be electrically coupled to the second NFC receiver, and a second end of the conductor of the third antenna may be electrically coupled to a second end of the conductor of the fourth antenna.

The first charging receiver may include a first magnetic core in the third antenna, and the second charging receiver may include a second magnetic core in the fourth antenna.

The system may further include a case including the charging transmitter; and first and second audio headphones including the first and second charging receivers, respectively, the first and second audio headphones configured to be inserted into the case, the third and fourth antennas configured to be inserted into the first and second antennas, respectively, while the first and second audio headphones are inserted in the case.

A system may be summarized as including a near field communication (NFC) poller including: an NFC transmitter; and a first antenna electrically coupled to the NFC transmitter; and an NFC listener including: an NFC receiver; a second antenna electrically coupled to the NFC receiver, one antenna of the first and second antennas is configured to be inserted into the other antenna of the first and second antennas; and a power storage configured to store power, the NFC poller configured to wirelessly charge the power storage through the first and second antennas while the one antenna is inserted into the other antenna.

The NFC transmitter may be configured to provide a first electrical signal to the first antenna, and the first antenna may be configured to induce a second electrical signal on the second antenna in response to receiving the first electrical signal.

Each of the first and second antennas may be a coil antenna.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly. the claims are not limited by the disclosure.

1. A system, comprising:
a first device including a charging transmitter, the charging transmitter including:
a near field communication (NFC) transmitter; and
a first antenna electrically coupled to the NFC transmitter, the NFC transmitter configured to provide a first electrical signal to the first antenna; and
a second device including a charging receiver, the charging receiver including:
an NFC receiver;
a second antenna electrically coupled to the NFC receiver, one antenna of the first and second antennas is configured to be inserted into the other antenna of the first and second antennas, the first antenna configured to induce a second electrical signal on the second antenna in response to receiving the first electrical signal;
charging circuitry configured to harvest power from the second electrical signal; and
a power storage configured to store the power.

2. The system of claim 1 wherein each of the first and second antennas is a coil antenna.

3. The system of claim 2 wherein each of the first and second antennas includes:
a body made of an insulating material; and
a conductor having a plurality of turns wrapped around the body.

4. The system of claim 3 wherein the body is cylindrical, and a diameter of the body of the first antenna is different from a diameter of the body of the second antenna.

5. The system of claim 3 wherein the conductor of the first antenna includes first and second ends electrically coupled to the NFC transmitter, and the conductor of the second antenna includes first and second ends electrically coupled to the NFC receiver.

6. The system of claim 1 wherein the NFC transmitter is configured to perform NFC communication with the NFC receiver using the first and second antennas.

7. The system of claim 1 wherein the charging transmitter includes a magnetic core in the first antenna.

8. The system of claim 1 wherein the charging receiver includes a magnetic core in the first antenna.

9. The system of claim 1 wherein
the first device is a mobile device, and the second device is a stylus configured to be inserted into the mobile device, or the first device is a charging stand, and the second device is a ring configured to be positioned on the charging stand.

10. The system of claim 1 wherein the first antenna is configured to be inserted into the second antenna.

11. The system of claim 1 wherein the second antenna is configured to be inserted into the first antenna.

12. A system, comprising:
a charging transmitter including:
a near field communication (NFC) transmitter;
a first antenna electrically coupled to the NFC transmitter; and
a second antenna electrically coupled to the NFC transmitter, the NFC transmitter configured to provide a first electrical signal to the first and second antennas;
a first charging receiver including:
a first NFC receiver;
a third antenna electrically coupled to the first NFC receiver, the third antenna configured to be inserted into the first antenna, the first antenna configured to induce a second electrical signal on the third antenna in response to receiving the first electrical signal;
first charging circuitry configured to harvest power from the second electrical signal; and
a first power storage configured to store the power harvested by the first charging circuitry; and
a second charging receiver including:
a second NFC receiver;
a fourth antenna electrically coupled to the second NFC receiver, the fourth antenna configured to be inserted into the second antenna, the second antenna configured to induce a third electrical signal on the fourth antenna in response to receiving the first electrical signal;
second charging circuitry configured to harvest power from the third electrical signal; and
a second power storage configured to store the power harvested by the second charging circuitry.

13. The system of claim 12 wherein each of the first, second, third, and fourth antennas is a coil antenna.

14. The system of claim 13 wherein each of the first, second, third, and fourth antennas includes:
a body made of an insulating material; and
a conductor having a plurality of turns wrapped around the body.

15. The system of claim 14 wherein
a first end of the conductor of the third antenna is electrically coupled to the first NFC receiver,
a first end of the conductor of the fourth antenna is electrically coupled to the second NFC receiver, and
a second end of the conductor of the third antenna is electrically coupled to a second end of the conductor of the fourth antenna.

16. The system of claim 12 wherein
the first charging receiver includes a first magnetic core in the third antenna, and
the second charging receiver includes a second magnetic core in the fourth antenna.

17. The system of claim 12, further comprising:
a case including the charging transmitter; and
first and second audio headphones including the first and second charging receivers, respectively, the first and second audio headphones configured to be inserted into the case, the third and fourth antennas configured to be inserted into the first and second antennas, respectively, while the first and second audio headphones are inserted in the case.

18. A system, comprising:
a near field communication (NFC) poller including:
an NFC transmitter; and
a first antenna electrically coupled to the NFC transmitter; and
an NFC listener including:
an NFC receiver;
a second antenna electrically coupled to the NFC receiver, one antenna of the first and second antennas is configured to be inserted into the other antenna of the first and second antennas; and
a power storage configured to store power, the NFC poller configured to wirelessly charge the power storage through the first and second antennas while the one antenna is inserted into the other antenna.

19. The system of claim 18 wherein the NFC transmitter is configured to provide a first electrical signal to the first antenna, and the first antenna is configured to induce a second electrical signal on the second antenna in response to receiving the first electrical signal.

20. The system of claim 18 wherein each of the first and second antennas is a coil antenna.
